(19) United States
(12) Patent Application Publication
(10) Pub. No.: US 2006/0194099 A1
(43) Pub. Date: Aug. 31, 2006

(54) Flexible fuel cell

(75) Inventors: Hsi-Ming Shu, Taipei (TW); Feng-Yi Deng, Taipei (TW); Ching-Tang Chan, Taipei (TW); Yean-Der Kuan, Taipei (TW)

Correspondence Address: G.LINK Co.,LTD, 3550 Bell Road,, MINOOKA, IL, 60447, US

(73) Assignee: ANTIG TECHNOLOGY Co, Ltd.

(21) Appl. No.: 11/067,005

(22) Filed: Feb. 28, 2005

(51) Int. Cl. H01M 8/02; H01M 8/24; H01M 8/10; H01M 8/04

(52) U.S. Cl. 429/127; 429/38; 429/32; 429/22

(57) ABSTRACT

The present invention is a flexible fuel cell, comprising at least one fuel supply unit and at least one power supply unit, characterized in that each power supply unit piles-up each anode current collection layer, membrane electrode assembly layer and each cathode current collection layer by flexible insulators and is able to construct versatile geometry shapes of flexible fuel cell structures.

### FIELD OF THE INVENTION

The present invention is related to a flexible fuel cell, especially to utilize the flexible substrate as the material required for the structure to construct versatile geometry shapes of flexible fuel cell structures.

### BACKGROUND OF THE INVENTION

The conventional fuel cell is to respectively offer hydrogen-included fuel and oxygen-included air on both sides of the proton exchange membrane to form the current loop by the oxidation-reduction reaction and therefore provide the electricity needed. This kind of fuel cell usually has a huge structure to provide a reactive environment and the fuel storage to make its suitable product constrained by a huge equipment like Cogeneration, power plant, car, submarine and space ship. However, from the demand point of view, many portable power requirements like versatile digital apparatuses of mobile phone, portable PC, walkman and camera need such a fuel cell of cheapness, long-time power supply, small volume, light weight and suitable for versatile environments. Although the conventional fuel cell has the merits of being economical and long-term usage, it is limited by the conventional structure to fail commonly used in many products. Therefore, the present invention, based on the disadvantages of used fuel cells to improve, invents a flexible fuel cell.

### SUMMARY OF THE INVENTION

The main object of the present invention is to provide a flexible fuel cell which is able to construct versatile geometry shapes and appearance structures to comply with the versatile usage requirement of cells.

To achieve the above object, the present invention provides a flexible fuel cell which comprises at least one fuel supply unit and at least one power supply unit and is characterized in that: each fuel supply unit has the flow guiding structure of plural fuel channels to offer the fuel for the reaction demand of the power supply unit; each power supply unit is constructed by piling an anode current collection layer, a first flexible substrate, a membrane electrode assembly layer, a second flexible substrate and a cathode current collection layer in order, wherein the first flexible substrate and the second substrate are constructed by the flexible insulators, and the first flexible substrate and the second flexible substrate form plural air vents to make each air vent of the first flexible substrate match the above fuel channel of the fuel supply unit to output the fuel, and also the second flexible substrate is able to input oxygen-included air; the anode current collection layer and cathode current collection layer are respectively placed on the first flexible substrate and the second flexible substrate to form to match the current guiding loop and control circuit of the membrane electrode assembly layer; the membrane electrode assembly layer forms plural regions for the current production by chemical reaction and is placed between the bottom surface of the first flexible substrate and the top surface of the second flexible substrate.

In order to make those familiar with the art understand the objects, characteristics and improvements, the present invention is described in details by way of the following embodiments and attached figures.

### BRIEF DESCRIPTION OF THE DRAWINGS

The above objects and advantages of the present invention will become more apparent with reference to the appended drawings wherein:

FIG. 1 shows the cross-sectional structural figure of the first embodiment of the present invention flexible fuel cell;

FIG. 2 shows the pillar-cell structural figure formed by utilizing the first embodiment of the present invention flexible fuel cell;

FIG. 3 shows the second embodiment of flexible fuel cell forming a curved surface structure by the present invention;

FIG. 4 shows the second embodiment of the present invention;

FIG. 5 shows the cross-sectional structural figure of the third embodiment of the present invention multi-layered roller-flexible fuel cell;

FIG. 6 shows the pillar-cell structural figure formed by utilizing the third embodiment of the present invention flexible fuel cell;

FIG. 7 shows the flow control valve figure of fuel trough in the present invention flexible fuel cell; and

FIG. 8 shows the cross-sectional structural figure of the fourth embodiment of the present invention flexible fuel cell.

### DETAILED DESCRIPTION OF THE INVENTION

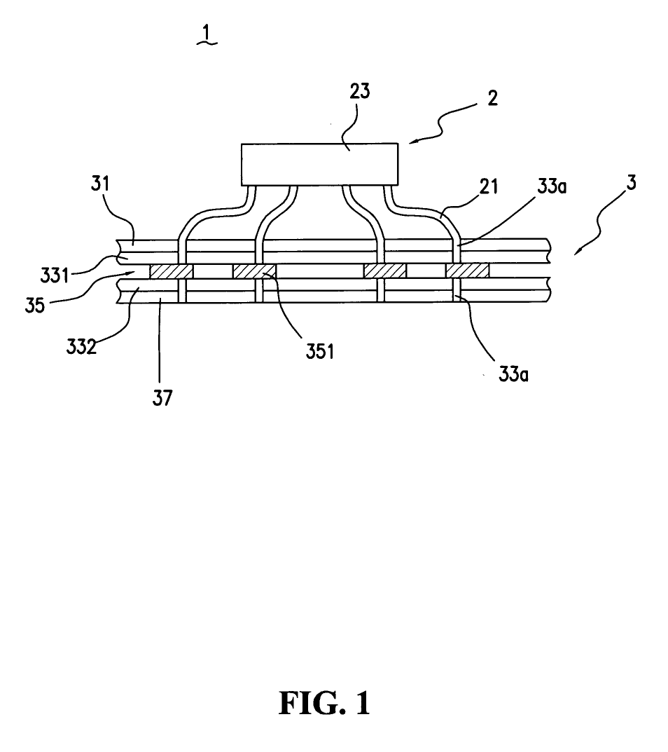

The present invention provides a flexible fuel cell which mainly utilizes the flexible substrate as the required substrate for the structure, for instance, using the flexible copper foil substrate made of copper foil and resin to construct the flexible fuel cell structure with versatile geometry shapes and appearance structures. Referring to FIG. 1 showing the cross-sectional structural figure of the first embodiment of the present invention flexible fuel cell, it has at least one fuel cell set 1 which includes a fuel supply unit 2 and a power supply unit 3, each component is described as bellows.

Fuel supply unit 2 has a flow guiding structure for plural fuel channels 21 to offer the methanol fuel or other fuels of possibly ionizing hydrogen atom required for the reaction of power supply unit 3. Furthermore, there are possibly plural fuel troughs 23 in the fuel supply unit 2 to store and offer the fuel for fuel channels 21.

Power supply unit 3 is constructed by piling an anode current collection layer 31, a first flexible substrate 331, a membrane electrode assembly layer 35, a second flexible substrate 332 and a cathode current collection layer 37 in order, wherein both first flexible substrate 331 and second flexible substrate 332 are constructed by the flexible insulator of epoxy or prepreg, and also both first flexible substrate 331 and second flexible substrate 332 form plural conducting holes to make each conducting hole 33a in the first substrate 331 matching the flow channel 21 of the above fuel supply unit 2 input the fuel; the second flexible substrate 332 possibly inputs the oxygen-included air. Anode current collection layer 31 and cathode current collection layer 37 are respectively placed on the first flexible substrate 331 and the second flexible substrate 332 and form the circuitry required for matching the current guiding loop and control circuit of the membrane electrode assembly layer 35 which forms plural regions to produce the current by the chemical reaction and is placed between the bottom surface of first flexible substrate 331 and the top surface of second flexible substrate 332.

The manufacture of the above anode current collection layer 31 and cathode current collection layer 37 utilizes the means of traditional print circuit board (PCB) process to plate the chemical copper with a thickness of 10 u to 50 u inches over whole substrates after drilling the flexible substrates 331 and 332, and again plates the copper with a thickness of 200 u to 500 u inches to therefore proceed film lamination, photo exposure, develop, and then plates the gold with a thickness of 3 u to 10 u inches and further etches the circuitry required for the current guiding loop and control circuit, accordingly completes the manufacture of anode current collection layer 31 and cathode current collection layer 37.

The above fuel supply unit 2 is possible a structure of independent and filling the fuel, and respectively forms each fuel channel 21 by plural channels to offer the fuel to every membrane electrode assembly units 351 of the membrane electrode assembly layer 35 in the power supply unit 3 so as to react with the oxygen under the oxidation-reduction reaction to produce a current loop.

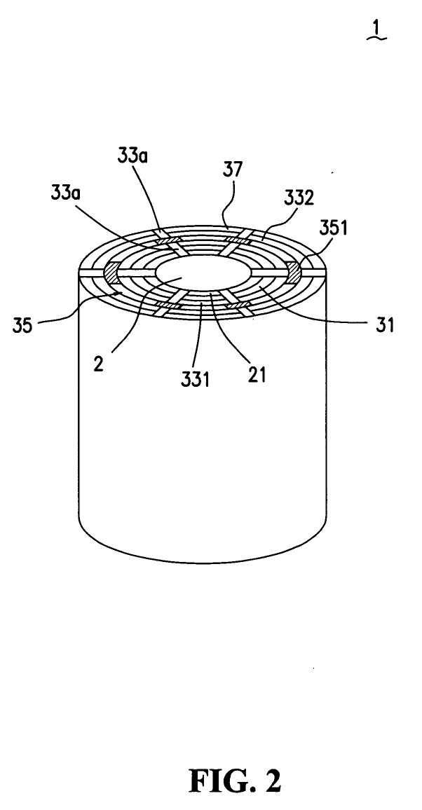

Referring to FIG. 2 showing the first embodiment of the above present invention flexible fuel cell, fuel cell set 1 comprise fuel supply unit 2 and power supply unit 3, wherein power supply unit 3 is a flexible substrate which surrounds to form a pillar structure, for instance, surrounding the flat power supply unit 3 to form a pillar structure and closing the top and bottom surfaces to make the hollow inside the pillar structure form a fuel trough 23 for the fuel supply unit 2, wherein each flow channel in the fuel trough 23 and the fuel supply unit 2 connects to each other to offer the fuel required for each fuel channel 21. Furthermore, the fuel supply unit 2 is a flow guiding structure with plural fuel channels 21 to offer the methanol fuel or other fuels of possibly ionizing hydrogen atom required for the power supply unit 3.

The above pillar structure of power supply unit 3 is possibly according to the requirement to form many geometries like the cylinder or triangle pillar or square pillar or hexagonal pillar or cubic, therefore, it possibly forms the shape of conventional alkaline battery or other battery shapes to provide the usage for these kinds of battery apparatuses.

Each fuel channel 21 in the above fuel supply unit 2 is possibly constructed by the flow guiding structure placed on a flexible substrate, and the flexible structure of the fuel supply unit 2 is possibly stacked on power supply unit 3 and also forms a pillar structure.

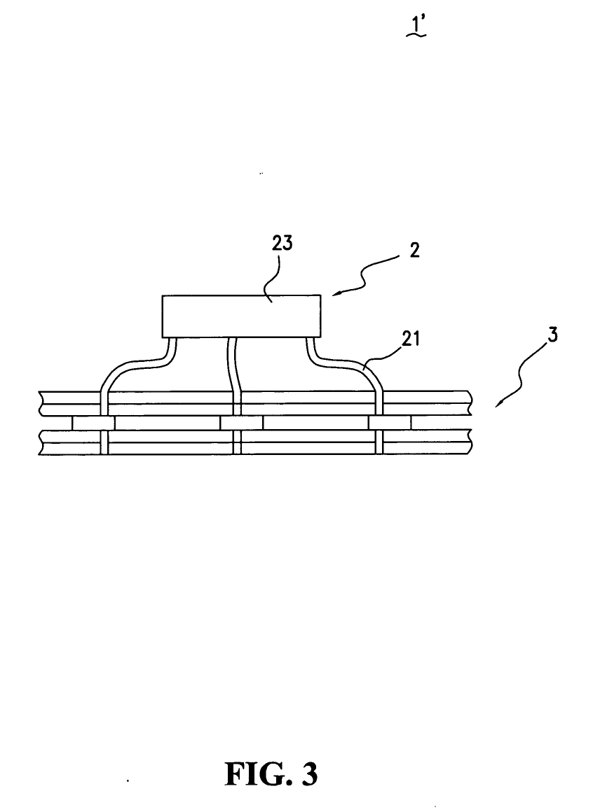

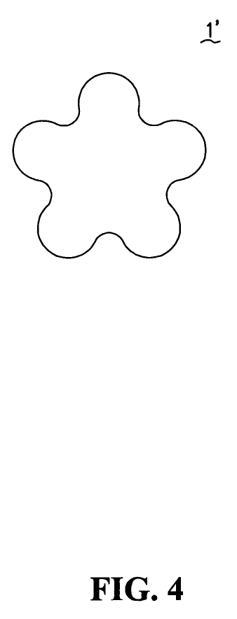

Referring to FIG. 3 showing the second embodiment of flexible fuel cell forming a curved surface structure by the present invention, the fuel cell set 1′ in FIG. 3 is mainly characterized in that power supply unit 3 is a curved surface structure like the wave-front structure. Based on the power supply unit of wave-front structure, referring to FIG. 4 showing the second embodiment of the present invention, the present invention surrounds the wave-front into a star pillar structure and closes its top and bottom surfaces to make the hollow inside the star pillar structure form the fuel trough 23 of fuel supply unit 2, wherein the fuel trough 23 connects to each fuel channel 21 in the fuel supply unit 2 to offer the fuel required for each fuel channel 21

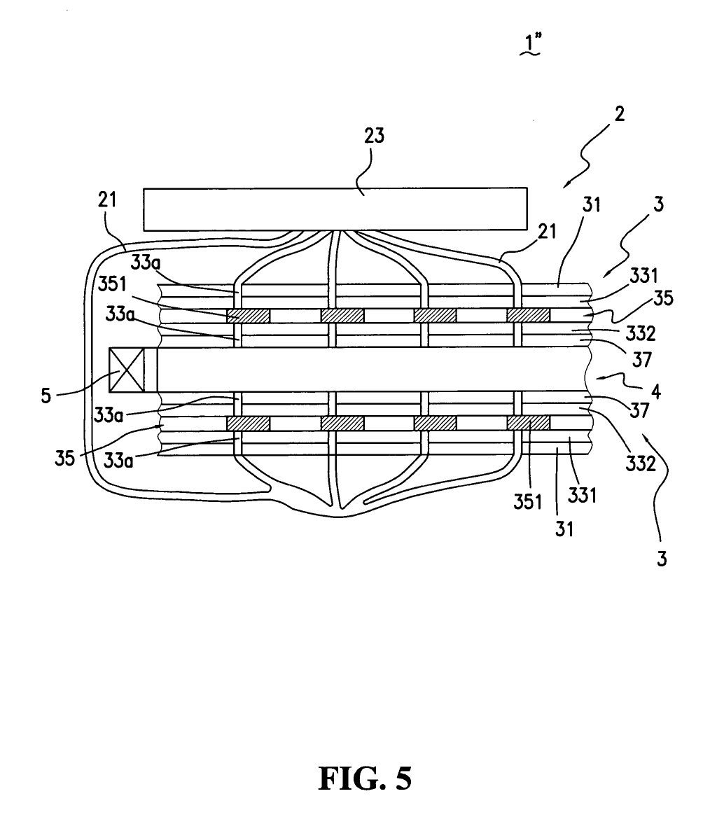

Referring to FIG. 5 showing the third embodiment of the present invention multi-layered roller-flexible fuel cell, the fuel cell set 1″ is to connect the cathode current collection layer 37 on the bottom of power supply unit 3 to another cathode current collection layer 37 on the bottom of the power supply unit 3 and forms an air flow channel 4 between these two cathode current collection layers 37, and also each membrane electrode assembly layer 35 of power supply units 3 respectively connects to a fuel supply unit 2 to make the fuel supply unit 2 possibly offer the fuel to the membrane electrode assembly layers 35, wherein the above fuel supply unit 2 and power supply units 3 have the same structures with the above embodiments and also the connection relationship between the fuel supply unit 2 and power supply unit 3 is the same with the above embodiments.

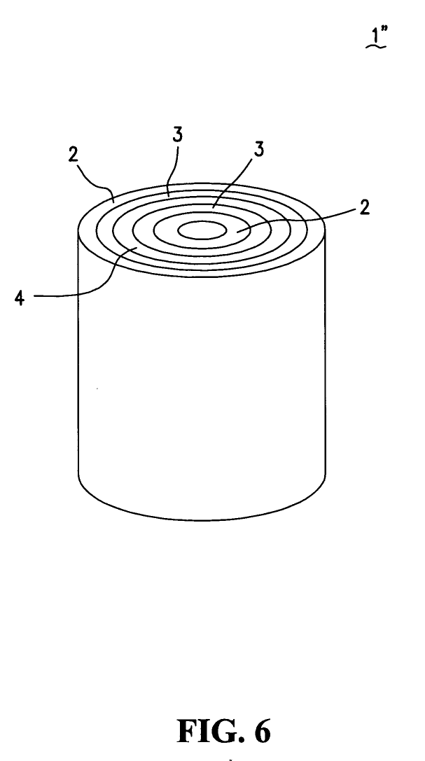

Referring to FIG. 6 showing the third embodiment of the present invention flexible fuel cell, each power supply unit 3 of the fuel cell set 1″ is a flexible substrate and surrounds to form a pillar structure, and also closes its top and bottom surfaces to make the hollow along the axis of the pillar structure form the fuel trough 23 of fuel supply unit 2, wherein the fuel trough 23 connects to each fuel channel 21 of fuel supply unit 2 to offer the fuel required for each fuel channel 21. Furthermore, the air flow channel 4 between two power supply units 3 is equipped with a flow control valve 5 which provides the flow control for the oxygen-included air.

The above fuel supply unit 2 is respectively formed on the internal surface of the anode current collection layer 31 of the internal power supply unit 3 and the external surface of the anode current collection layer 31 of the external power unit 3.

The above flow control valve 5 includes a fan to provide air input and conduct into the membrane electrode assembly units 351 of membrane electrode assembly layer 35 in the power supply unit 3 by the air flow channel 4 for the oxidation-reduction reaction.

The above flow control valve 5 includes a flow switch to provide stopping or opening the air input so as to achieve the stopping or opening the air input to conduct into the membrane electrode assembly layer 35 of power supply unit 3 and therefore cease the oxidation-reduction reaction.

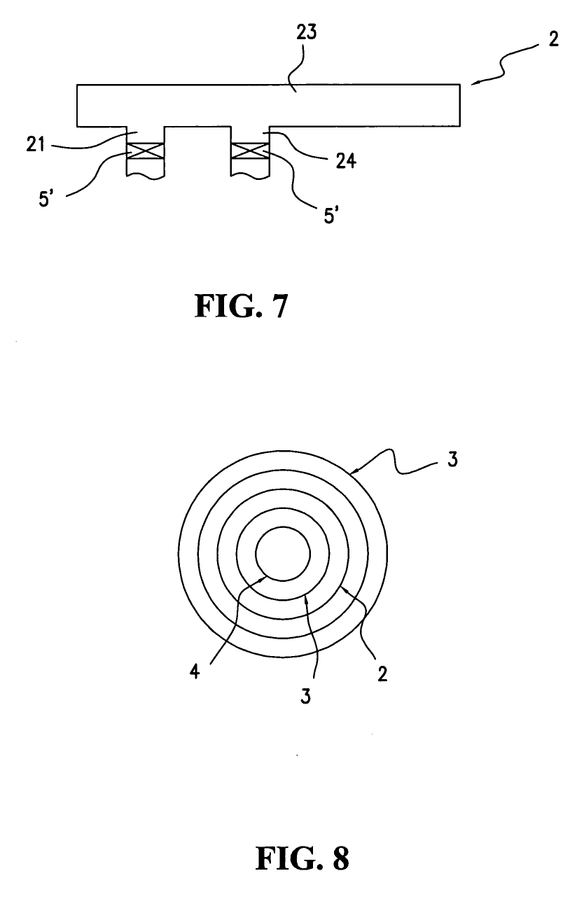

Referring to FIG. 7, each fuel channel 21 or fuel trough 23 in the above fuel supply unit 2 is possibly equipped with a flow control valve 5′ to control the fuel flux.

Referring to FIG. 8, the pillar structure formed in the above first, second and third embodiments is possible to inverse the order of piling the anode 31, first flexible substrate 331, membrane electrode assembly layer 35, second flexible substrate 332 and cathode current collection layer 37 in the power supply unit 3 to make the hollow inside the pillar structure form the air flow channel 4, and two power supply unit 3 of the third embodiments form the fuel trough 23.

The present invention flexible fuel cell has the following effects:
1. The present invention flexible fuel cell has the feature of easy flexibility to form a curve-surfaced shape and increase the surface area to in advance produce larger current or voltage;
2. The present invention flexible fuel cell is possible to form versatile geometry shapes of batteries and therefore comply with each spec of battery sold in the current market; and
3. In the present invention flexible fuel cell, the fuel supply unit is possibly to form a flexible layered structure with the power supply unit to achieve the effect of miniaturizing the volume.

Although the present invention has been disclosed one embodiment as the above, it does not imply to limit the present invention, any person who is skilled in the art can make any change or modification within the spirit and scope of the present invention, however, it is belongs to the scope of the present invention, the protective scope of the present invention is defined by the following claims.

What is claimed is:

1. A flexible fuel cell, comprising at least one fuel supply unit and at least one power supply unit, is characterized in that:
the fuel supply unit has a flow guiding structure for plural fuel channels to offer the fuel required for the power supply unit;
each power supply unit is constructed by piling an anode current collection layer, a first flexible substrate, a membrane electrode assembly layer, a second flexible substrate and a cathode current collection layer in order, wherein the first flexible substrate and the second flexible substrate are constructed by the flexible insulators, and the first flexible substrate and the second flexible substrate form plural air vents to make each air vent of the first flexible substrate match the fuel channels of the fuel supply unit to output the fuel, and also the second flexible substrate is able to input oxygen-included air; the anode current collection layer and cathode current collection layer are respectively placed on the first flexible substrate and the second flexible substrate to form for matching the current guiding loop and control circuit of the membrane electrode assembly layer; the membrane electrode assembly layer forms plural regions for the current production by chemical reaction and is placed between the first flexible substrate and the second flexible substrate.

2. The flexible fuel cell according to claim 1, wherein the power supply unit surround to form a pillar structure and closes the top and bottom surfaces to make the hollow inside the pillar structure form a fuel trough of the fuel supply unit, the fuel trough connects to each fuel channel of the fuel supply unit to offer the fuel required for each fuel flow channel, and also offer the fuel required for the reaction of the power supply unit by each fuel flow channel.

3. The flexible fuel cell according to claim 2, wherein the power supply unit surrounding to form the pillar structure is denoted as the block formed by the equal cross-section, such as cylinder, multi-faced pillar and cubic.

4. The flexible fuel cell according to claim 2, wherein the power supply unit of the pillar structure having the components piled in order form the outside to the inside are the anode current collection layer, the first flexible substrate, the membrane electrode assembly layer, the second flexible substrate and the cathode current collection layer, and also forms the air flow channel in the hollow along the axis of the pillar structure.

5. The flexible fuel cell according to claim 4, wherein the air flow channel is in advance equipped a flow control valve to control the air flux.

6. The flexible fuel cell according to claim 5, wherein the flow control valve includes a fan to offer the air input and conduct into the membrane electrode assembly layer of the power supply unit by the air flow channel to proceed the oxidation-reduction reaction.

7. The flexible fuel cell according to claim 5, wherein the flow control valve includes a flow switch to offer the stopping or opening for the air input to achieve for the stopping or opening the air conducting into the membrane electrode assembly layer of the power supply unit to cease the oxidation-reduction reaction.

8. The flexible fuel cell according to claim 2, wherein each fuel flow channel or fuel trough in the fuel supply unit is in advance equipped a flow control valve to control the fuel flux.

9. The flexible fuel cell according to claim 1, wherein each fuel flow channel or fuel trough in the fuel supply unit is constructed by placing a flow guiding structure on a flexible substrate, and the flexible structure of the fuel supply unit is possibly piled upon the power supply unit, and also forms a pillar structure to make the fuel trough connect to each fuel flow channel of the fuel supply unit to offer the fuel required for each fuel flow channel and the fuel required for the reaction of the power supply unit by each fuel flow channel.

10. The flexible fuel cell according to claim 1, wherein the shape of the power supply unit is flat.

11. The flexible fuel cell according to claim 1, wherein the shape of the power supply unit is curve-surfaced.

12. The flexible fuel cell according to claim 1, wherein the flexible fuel cell is a flexible direct methanol fuel cell.

13. A multi-layered flexible fuel cell, comprising at least one fuel supply unit and at least two power supply units, is characterized in that:
each power supply unit is constructed by piling an anode current collection layer, a first flexible substrate, a membrane electrode assembly layer, a second flexible substrate and a cathode current collection layer in order, wherein the first flexible substrate and the second flexible substrate are constructed by the flexible insulators, and the first flexible substrate and the second flexible substrate form plural air vents to make each air vent of the first flexible substrate match the above fuel channel of the fuel supply unit to output the fuel, and also the second flexible substrate is able to input oxygen-included air; the anode current collection layer and cathode current collection layer are respectively placed on the first flexible substrate and the second flexible substrate to form for matching the current guiding loop and control circuit of the membrane electrode assembly layer; the membrane electrode assembly layer forms plural regions for the current production by chemical reaction and is placed between the bottom surface of the first flexible substrate and the top surface of the second flexible substrate; and also the cathode current collection layer on the bottom of the power supply unit connects to the cathode current collection layer of another power supply unit to form a air flow channel between these two cathode current collection layers, and again the membrane electrode assembly layer of each power supply unit respectively connects to the fuel supply unit to make the fuel supply unit possibly offer fuel to the membrane electrode assembly layer.

14. The multi-layered flexible fuel cell according to claim 13, wherein the power supply unit surround to form a pillar structure and closes the top and bottom surfaces to make the hollow inside the pillar structure form a fuel trough of the fuel supply unit, the fuel trough connects to each fuel channel of the fuel supply unit to offer the fuel required for each fuel flow channel, and also offer the fuel required for the reaction of the power supply unit by each fuel flow channel.

15. The multi-layered flexible fuel cell according to claim 14, wherein the power supply unit surrounding to form the pillar structure is denoted as the block formed by the equal cross-section, such as cylinder, multi-faced pillar and cubic.

16. The multi-layered flexible fuel cell according to claim 13, wherein each fuel flow channel or fuel trough in the fuel supply unit is constructed by placing a flow guiding structure on a flexible substrate, and the flexible structure of the fuel supply unit is possibly piled upon the power supply unit, and also forms a pillar structure to make the fuel trough connect to each fuel flow channel of the fuel supply unit to offer the fuel required for each fuel flow channel and the fuel required for the reaction of the power supply unit by each fuel flow channel.

17. The multi-layered flexible fuel cell according to claim 13, wherein the air flow channel is in advance equipped a flow control valve to control the air flux.

18. The multi-layered flexible fuel cell according to claim 17, wherein the flow control valve includes a fan to offer the air input and conduct into the membrane electrode assembly layer of the power supply unit by the air flow channel to proceed the oxidation-reduction reaction.

19. The multi-layered flexible fuel cell according to claim 17, wherein the flow control valve includes a flow switch to offer the stopping or opening for the air input to achieve for the stopping or opening the air conducting into the membrane electrode assembly layer of the power supply unit to cease the oxidation-reduction reaction.

20. The multi-layered flexible fuel cell according to claim 13, wherein the multi-layered flexible fuel cell is a multi-layered flexible direct methanol fuel cell.
